(19) United States
(12) Patent Application Publication
(10) Pub. No.: US 2026/0353411 A1
(43) Pub. Date: Nov. 5, 2026

(54) METHODS AND APPARATUSES FOR RESOURCE ALLOCATION IN UNLICENSED SPECTRA

(71) Applicant: Lenovo (Beijing) Limited, Beijing (CN)

(72) Inventors: Xin Guo, Beijing (CN); Haipeng Lei, Beijing (CN); Zhennian Sun, Beijing (CN); Xiaodong Yu, Beijing (CN)

(73) Assignee: Lenovo (Beijing) Limited, Beijing (CN)

(21) Appl. No.: 19/112,851

(22) PCT Filed: Sep. 30, 2022
(86) PCT No.: PCT/CN2022/123491

§ 371 Date: Mar. 18, 2025

(51) Int. Cl. H04W 72/25; H04L 27/26

(52) U.S. Cl. CPC H04W 72/25; H04L 27/26025

(57) ABSTRACT

Embodiments of the present disclosure relate to methods and apparatuses for resource allocation in unlicensed spectra. According to an embodiment of the present disclosure, a user equipment (UE) can include: a processor configured to: determine candidate resource(s) in a selection window (SW) for a sidelink (SL) transmission based on sidelink synchronization signal block (S-SSB) transmission(s) on S-SSB occasion(s) which is (are) located outside the SW; and perform the SL transmission on resource(s) selected from the candidate resource(s); a transmitter coupled to the processor; and a receiver coupled to the processor.

### TECHNICAL FIELD

Embodiments of the present application are related to wireless communication technology, and more particularly, related to methods and apparatuses for resource allocation in unlicensed spectra.

### BACKGROUND

A sidelink (SL) is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in a sidelink synchronization signal block (S-SSB). In an unlicensed spectrum, SL transmissions and S-SSB transmissions may be multiplexed in some cases. Therefore, new designs for resource allocation for SL transmissions and S-SSB transmissions in unlicensed spectra are needed.

### SUMMARY OF THE APPLICATION

Embodiments of the present application at least provide a technical solution for resource allocation for SL transmissions and S-SSB transmissions in unlicensed spectra.

According to some embodiments of the present application, a UE may include: a processor configured to: determine candidate resource(s) in a selection window (SW) for an SL transmission based on S-SSB transmission(s) on S-SSB occasion(s) which is (are) located outside the SW; and perform the SL transmission on resource(s) selected from the candidate resource(s); a transmitter coupled to the processor; and a receiver coupled to the processor.

In some embodiments of the present application, the processor is further configured to obtain configuration information for S-SSB detection based on configuration or pre-configuration, wherein the configuration information for S-SSB detection indicates at least one of: a first trigger condition of S-SSB detection for first UEs performing SL transmission; a second trigger condition of S-SSB detection for second UEs receiving SL transmission; a first minimum number of S-SSB occasion(s) for detection; a second minimum number of S-SSB transmission(s) detected on S-SSB occasion(s); or a third minimum number of S-SSB(s) transmitted on S-SSB occasion(s).

In some embodiments of the present application, the first trigger condition indicates that: the first UEs do not perform S-SSB detection, the first UEs perform S-SSB detection, or whether each first UE performs S-SSB detection is triggered by the first UE's implementation; and/or the second trigger condition indicates that: the second UEs do not perform S-SSB detection, the second UEs perform S-SSB detection, or whether each second UE performs S-SSB detection is triggered by the second UE's implementation.

In some embodiments of the present application, the first minimum number is a fixed value or based on a subcarrier spacing (SCS); the second minimum number is a fixed value or based on the SCS; and/or the third minimum number is a fixed value or based on the SCS.

In some embodiments of the present application, the receiver is configured to receive the configuration information via at least one of: a master information block (MIB) message, a system information block (SIB) message, a radio resource control (RRC) signaling, a medium access control (MAC) control element (CE), or downlink control information (DCI).

In some embodiments of the present application, in the case that (1) the UE does not transmit S-SSB, (2) a number of S-SSB occasion(s) between a slot where a resource selection for the SL transmission is triggered and a starting point of the SW is greater than or equal to the first minimum number, and (3) the UE does not perform S-SSB detection, the processor is further configured to exclude all class-2 S-SSB occasions within the SW from the candidate resource(s) at the slot, wherein the class-2 S-SSB occasions are included within a resource pool in the time domain.

In some embodiments of the present application, in the case that (1) the UE does not transmit S-SSB, (2) a number of S-SSB occasion(s) between a slot where a resource selection for the SL transmission is triggered and a starting point of the SW is greater than or equal to the first minimum number, and (3) the UE performs S-SSB detection, the processor is further configured to: include, at the slot, all class-2 S-SSB occasions within the SW in the candidate resource(s), wherein the class-2 S-SSB occasions are included within a resource pool in the time domain; perform S-SSB detection on S-SSB occasion(s) between the slot and the starting point of the SW; and remain all the class-2 S-SSB occasions within the SW in the candidate resource(s) in the case that a second condition is met, or exclude all the class-2 S-SSB occasions within the SW from the candidate resource(s) in the case that the second condition is not met, wherein the second condition is that a number of detected S-SSB transmission(s) within an S-SSB period where the SW is included is greater than or equal to the second minimum number.

In some embodiments of the present application, in the case that (1) the UE does not transmit S-SSB, and (2) a number of S-SSB occasion(s) between a slot where a resource selection for the SL transmission is triggered and a starting point of the SW is less than the first minimum number, the processor is further configured to: in the case that the UE does not perform S-SSB detection on S-SSB occasion(s) prior to the slot, exclude all class-2 S-SSB occasions within the SW from the candidate resource(s), wherein the class-2 S-SSB occasions are included within a resource pool in the time domain; in the case that the UE performs S-SSB detection on the S-SSB occasion(s) prior to the slot but a second condition is not met, exclude all the class-2 S-SSB occasions within the SW from the candidate resource(s); or in the case that the UE performs S-SSB detection on the S-SSB occasion(s) prior to the slot and the second condition is met, include all the class-2 S-SSB occasions within the SW into the candidate resource(s), wherein the second condition is that a number of detected S-SSB transmission(s) within an S-SSB period where the SW is included is greater than or equal to the second minimum number.

In some embodiments of the present application, in the case that the UE needs to transmit S-SSB, the processor is further configured to perform a listen before talk (LBT) type 2 procedure prior to a target S-SSB occasion when the UE intends to transmit an S-SSB on the target S-SSB occasion.

In some embodiments of the present application, in the case that (1) the UE needs to transmit S-SSB and (2) a number of S-SSB occasion(s) between a slot where a resource selection for the SL transmission is triggered and a starting point of the SW is greater than or equal to the first minimum number, the processor is further configured to: include, at the slot, all class-2 S-SSB occasions within the SW in the candidate resource(s), wherein the class-2 S-SSB occasions are included within a resource pool in the time domain; attempt to transmit S-SSB(s) on S-SSB occasion(s) prior to the SW within an S-SSB period where the SW is included; and remain all the class-2 S-SSB occasions within the SW in the candidate resource(s) in the case that a number of S-SSB(s) transmitted on the S-SSB occasion(s) prior to the SW in the S-SSB period is greater than or equal to the third minimum number, or exclude all the class-2 S-SSB occasions within the SW from the candidate resource(s) in the case that the number of S-SSB(s) transmitted on the S-SSB occasion(s) prior to the SW in the S-SSB period is less than the third minimum number.

In some embodiments of the present application, in the case that (1) the UE needs to transmit S-SSB and (2) a number of S-SSB occasion(s) between a slot where a resource selection for the SL transmission is triggered and a starting point of the SW is less than the first minimum number, the processor is further configured to: in the case that a number of S-SSB(s) transmitted on S-SSB occasion(s) prior to the slot within an S-SSB period where the SW is included is greater than or equal to the third minimum number, include all class-2 S-SSB occasions within the SW in the candidate resource(s), wherein the class-2 S-SSB occasions are included within a resource pool in the time domain; or in the case that the number of S-SSB(s) transmitted on the S-SSB occasion(s) prior to the slot within the S-SSB period is less than the third minimum number, exclude all the class-2 S-SSB occasions within the SW from the candidate resource(s).

According to some other embodiments of the present application, a UE may include: a processor configured to determine whether to perform a detection for an SL transmission on a class-2 S-SSB occasion based at least in part on whether the UE performs S-SSB detection, wherein the class-2 S-SSB occasion is included within a resource pool in the time domain; a transmitter coupled to the processor; and a receiver coupled to the processor.

In some embodiments of the present application, the processor is further configured to obtain configuration information for S-SSB detection based on configuration or pre-configuration, wherein the configuration information for S-SSB detection indicates at least one of the following: a first trigger condition of S-SSB detection for first UEs performing SL transmission; a second trigger condition of S-SSB detection for second UEs receiving SL transmission; a first minimum number of S-SSB occasion(s) for detection; a second minimum number of S-SSB transmission(s) detected on S-SSB occasion(s); or a third minimum number of S-SSB(s) transmitted on S-SSB occasion(s).

In some embodiments of the present application, the first trigger condition indicates that: the first UEs do not perform S-SSB detection, the first UEs perform S-SSB detection, or whether each first UE performs S-SSB detection is triggered by the first UE's implementation; and/or the second trigger condition indicates that: the second UEs do not perform S-SSB detection, the second UEs perform S-SSB detection, or whether each second UE performs S-SSB detection is triggered by the second UE's implementation.

In some embodiments of the present application, the first minimum number is a fixed value or based on an SCS; the second minimum number is a fixed value or based on the SCS; and/or the third minimum number is a fixed value or based on the SCS.

In some embodiments of the present application, the receiver is configured to receive the configuration information via at least one of: a MIB message, a SIB message, an RRC signaling, a MAC CE, or DCI.

In some embodiments of the present application, in the case that the UE does not perform S-SSB detection on S-SSB occasion(s) prior to the class-2 S-SSB occasion within an S-SSB period including the class-2 S-SSB occasion based on configuration or pre-configuration, the processor is further configured to perform a detection for the SL transmission on the class-2 S-SSB occasion.

In some embodiments of the present application, whether to perform S-SSB detection is based on the UE's implementation; and in the case that the UE does not perform S-SSB detection on S-SSB occasion(s) prior to the class-2 S-SSB occasion within an S-SSB period including the class-2 S-SSB occasion, the processor is further configured to perform a detection for the SL transmission on the class-2 S-SSB occasion; in the case that the UE performs S-SSB detection on the S-SSB occasion(s) prior to the class-2 S-SSB occasion within the S-SSB period and a number of detected S-SSB transmission(s) within the S-SSB period is greater than or equal to the second minimum number, the processor is further configured to perform a detection for the SL transmission on the class-2 S-SSB occasion; or in the case that the UE performs S-SSB detection on the S-SSB occasion(s) prior to the class-2 S-SSB occasion within the S-SSB period and the number of detected S-SSB transmission(s) within the S-SSB period is less than the second minimum number, the processor is further configured not to perform a detection for the SL transmission on the class-2 S-SSB occasion.

In some embodiments of the present application, in the case that (1) the UE performs S-SSB detection on S-SSB occasion(s) prior to the class-2 S-SSB occasion within an S-SSB period including the class-2 S-SSB occasion based on configuration or pre-configuration, and (2) a number of detected S-SSB transmission(s) within the S-SSB period is greater than or equal to the second minimum number, the processor is further configured to perform a detection for the SL transmission on the class-2 S-SSB occasion.

According to some other embodiments of the present application, a BS may include: a transmitter configured to: transmit configuration information for S-SSB detection, wherein the configuration information for S-SSB detection includes at least one of: a first trigger condition of S-SSB detection for first UEs performing SL transmission; a second trigger condition of S-SSB detection for second UEs receiving SL transmission; a first minimum number of S-SSB occasion(s) for detection; a second minimum number of S-SSB transmission(s) detected on S-SSB occasion(s); or a third minimum number of S-SSB(s) transmitted on S-SSB occasion(s); and a processor coupled to the transmitter; and a receiver coupled to the processor.

In some embodiments of the present application, the first trigger condition indicates that: the first UEs do not perform S-SSB detection, the first UEs perform S-SSB detection, or whether each first UE performs S-SSB detection is triggered by the first UE's implementation; and/or the second trigger condition indicates that: the second UEs do not perform S-SSB detection, the second UEs perform S-SSB detection, or whether each second UE performs S-SSB detection is triggered by the second UE's implementation.

In some embodiments of the present application, the first minimum number is a fixed value or based on an SCS; the second minimum number is a fixed value or based on the SCS; and/or the third minimum number is a fixed value or based on the SCS.

In some embodiments of the present application, the transmitter is configured to transmit the configuration information for S-SSB detection via at least one of: a MIB message, a SIB message, an RRC signaling, a MAC CE, or DCI.

According to some embodiments of the present application, a method performed by a UE may include: determining candidate resource(s) in an SW for an SL transmission based on S-SSB transmission(s) on S-SSB occasion(s) which is (are) located outside the SW; and performing the SL transmission on resource(s) selected from the candidate resource(s).

According to some other embodiments of the present application, a method performed by a UE may include: determining whether to perform a detection for an SL transmission on a class-2 S-SSB occasion based at least in part on whether the UE performs S-SSB detection, wherein the class-2 S-SSB occasion is included within a resource pool in the time domain.

According to some other embodiments of the present application, a method performed by a BS may include: transmitting configuration information for S-SSB detection, wherein the configuration information for S-SSB detection includes at least one of: a first trigger condition of S-SSB detection for first UEs performing SL transmission; a second trigger condition of S-SSB detection for second UEs receiving SL transmission; a first minimum number of S-SSB occasion(s) for detection; a second minimum number of S-SSB transmission(s) detected on S-SSB occasion(s); or a third minimum number of S-SSB(s) transmitted on S-SSB occasion(s).

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary sensing-based resource (re-)selection procedure according to some embodiments of the present application;

FIG. 3 illustrates an exemplary S-SSB slot according to some embodiments of the present application;

FIG. 4 illustrates an exemplary distribution of S-SSB occasions in the time domain according to some embodiments of the present application;

FIG. 5 illustrates another exemplary distribution of S-SSB occasions in the time domain according to some other embodiments of the present application;

FIG. 6 illustrates yet another exemplary distribution of S-SSB occasions in the time domain according to some other embodiments of the present application;

FIG. 7 illustrates a flowchart of an exemplary method for resource allocation in an unlicensed spectrum according to some embodiments of the present application;

FIG. 8 illustrates an exemplary SW within an S-SSB period according to some embodiments of the present application; and

FIG. 9 illustrates a simplified block diagram of an exemplary apparatus for resource allocation in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

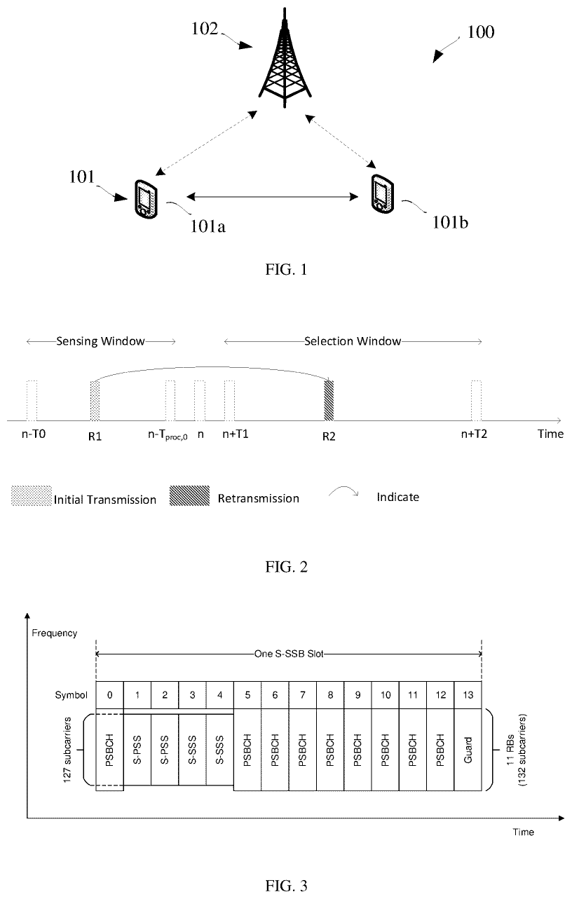

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectra, whereas in other embodiments, UE 101a may communicate with UE 101b over unlicensed spectra.

Both UE 101a and UE 101b in the embodiments of FIG. 1 may transmit information to BS 102 and receive control information from BS 102, for example, via LTE or NR Uu interface. BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

For sidelink transmission, resource allocation may be implemented by two modes, i.e., resource allocation mode 1 and resource allocation mode 2.

In the case of resource allocation mode 1, a sidelink transmission (e.g., a physical sidelink shared channel (PSSCH) transmission and/or a physical sidelink control channel (PSCCH) transmission) can only be carried out by a UE if the UE has been provided with a valid scheduling grant that indicates the exact set of resources used for the sidelink transmission. Resource allocation mode 1 is applicable to the in-coverage deployment scenario.

In the case of resource allocation mode 2, a decision on sidelink transmission, including decision on the exact set of resources to be used for the sidelink transmission, is made by the transmitting UE (also referred to as Tx UE) based on a sensing-based resource (re-)selection procedure. Resource allocation mode 2 is applicable to both in-coverage and out-of-coverage deployment scenarios.

FIG. 2 illustrates an exemplary sensing-based resource (re-)selection procedure according to some embodiments of the present application. The procedure in FIG. 2 may be used for selecting a slot level resource for a slot level sidelink transmission.

Referring to FIG. 2, the resource (re-)selection is triggered at a slot n by a UE or new resource(s) for transmitting a TB must be selected at slot n by the UE. The UE may define an SW in which the UE determines candidate resources for transmitting the TB. The SW may start at slot n+T1 and end at slot n+T2, wherein T1 and T2 are constrained by conditions as specified in 3GPP standard documents.

Once the SW is defined, the UE may identify a set of candidate resources (referred to as set “S”) within the SW. The set “S” may include all the candidate resources within the SW. For example, a candidate resource (e.g., a slot level candidate resource) may be denoted by a slot in the time domain and L_{PSSCH} contiguous sub-channels in the frequency domain. L_{PSSCH} is a positive integer and may depend on a size of the TB and associated sidelink control information (SCI) as well as the modulation and coding scheme (MCS) utilized by the UE for transmitting the TB.

In order to select candidate resources from the set “S”, the UE may perform a sensing operation in a sensing window which starts at slot n-T0 and ends at slot n-T_{proc,0}, wherein T0 and T_{proc,0} are constrained by conditions as specified in 3GPP standard documents.

During the sensing operation, the UE may sense SL resources within the sensing window, and decode SCIs (e.g., 1^{st}-stage SCIs) received from other UEs on the sensed SL resources. For example, an initial transmission of a TB detected in the sensing window may include associated SCI. The 1^{st}-stage SCIs may indicate SL resources that other UEs have reserved for their TB and SCI transmissions in PSSCH and PSCCH. In addition, the UE may also measure reference signal receiving powers (RSRPs) of transmissions associated with the 1^{st}-stage SCIs from other UEs. For example, as shown in FIG. 2, the UE may detect an initial transmission on resource R1 within the sensing window indicating a reserved resource in slot R2 within the SW.

After performing the sensing operation, the UE may use the sensing results (e.g., the decoded 1^{st}-stage SCIs and the measured RSRPs) to select candidate resources from the set “S” for transmitting the TB of the UE. For example, the selection may include the following steps:
1) Step 1: the UE may determine which candidate resources from the SW should be excluded, based on the sensing results (e.g., the decoded 1^{st}-stage SCIs and the measured RSRPs), to obtain a set of available candidate resources (referred to as set “S1”). That is, the set “S1” is constructed by excluding the determined candidate resources from the set “S.” For example, the excluding may include at least one of the following:
   a) First, the UE may exclude candidate resources whose reservation cannot be determined by the UE based on the sensing results in the sensing window due to half-duplexing of the UE. For example, if the UE transmits information in slot sᵢ in the sensing window, then it cannot sense SCI in slot sᵢ due to half-duplexing, so it may exclude all candidate resources which are possibly reserved by SCI in slot sᵢ. The candidate resources which are possibly reserved by SCI in slot sᵢ may be included in slot sᵢ+q*RRIᵢ (q=1, 2, 3 . . . ) within the selection window, wherein RRIᵢ represents all the possible values of a resource reservation interval (RRI) based on a list of permitted RRIs in the resource pool as specified in 3GPP standard documents.
   b) Second, the UE may exclude candidate resources based on the reservations from other UEs indicated by the 1^{st}-stage SCIs detected during the sensing window. Specifically, a candidate resource may be excluded only if a measured RSRP (e.g., an RSRP of an SL transmission associated with the 1^{st}-stage SCI detected in the sensing window and indicating that the candidate resource is reserved for an SL transmission of another UE) associated with the candidate resource is higher than an RSRP threshold, wherein the RSRP threshold utilized by the UE may depend on at least one of (1) the priority of the TB for which the UE selects the candidate resources (also the priority of the SL transmission to be performed by the UE) or (2) the priority of a TB for which the another UE reserves the resource (also the priority of the SL transmission of the another UE).

2) Step 2: the UE may perform a checking process. That is, after executing all exclusions in step 1, the UE may check whether the candidate resources in the set “S1” is equal to or higher than a threshold ratio (e.g., X %) of candidate resources in the set “S.” If not, the RSRP threshold may be increased by a pre-defined step (e.g., 3 dB), and step 1 is repeated by utilizing the increased RSRP threshold until X % is fulfilled. If yes, the set “S1” will be transmitted to a higher layer (e.g., a layer higher than physical layer) of the UE. For example, possible values of X include 20, 35 or 50. In some embodiments, the UE may select the value of X based on a priority of the TB for which the UE selects the candidate resources.

Then, the UE may randomly select candidate resource(s) from the set “S1” for transmitting the TB.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a channel occupancy time (COT). During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on listen-before-talk (LBT), where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mₚ” in the following Table 1 or Table 2, which will be illustrated below) of 9 μs slots. As shown in Table 1 and Table 2, a value of “mₚ” depends on a value of channel access priority class (CAPC) (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., denoted by the random number multiplying 9 μs) before transmission can take place. The value of “CW” may be selected from “allowed CWₚ sizes” (the minimum value is represented as CWₘᵢₙₚ, and the maximum value is represented as CW_{max,p}) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to MCOT (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CWₘᵢₙₚ, CW_{max,p}, T_{mcot,p}, T_{ulmcot,p}, and allowed CWₚ sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CWₘᵢₙₚ, CW_{max,p}, T_{mcot,p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CWₘᵢₙₚ, CW_{max,p}, T_{ulmcot,p} and allowed CWₚ sizes) used in the Type-1 channel access procedure according to Table 2.

TABLE 1
Channel Access Priority Class for DL

| Channel | | | | | |
|---|---|---|---|---|---|
| Access | | | | | |
| Priority | | | | | |
| Class (p) | mₚ | CW_{min, p} | CW_{max, p} | T_{mcot, p} | allowed CWₚ sizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, 255, |
| | | | | 10 ms | 511, 1023} |

TABLE 2
Channel Access Priority Class for UL

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further divided into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 us immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 3 illustrates an exemplary S-SSB slot according to some embodiments of the present disclosure. In the embodiments of FIG. 3, a normal cyclic prefix (CP) is used.

Referring to FIG. 3, an S-SSB occupies one slot in the time domain and occupies 11 resource blocks (RBs) in the frequency domain. Each RB spans 12 subcarriers, thus the S-SSB bandwidth is 132 (11×12) subcarriers. In the example of FIG. 3, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE V2X. Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 3, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

A UE may be configured with a configuration for an S-SSB period including one or more S-SSB occasions.

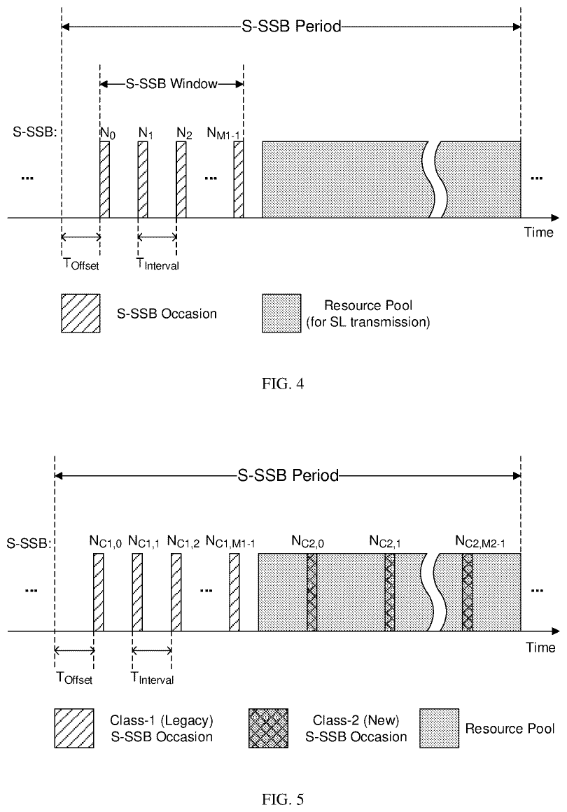

FIG. 4 illustrates an exemplary distribution of S-SSB occasions in the time domain according to some embodiments of the present disclosure.

In FIG. 4, it illustrates an S-SSB period as an example. Referring to FIG. 4, one S-SSB window is included in one S-SSB period. It is contemplated that more S-SSB windows can be included in one S-SSB period in other examples. The S-SSB period may also include resource(s) for SL transmission, which does not overlap with the S-SSB occasions in the time domain. A resource pool may define the overall time and frequency domain resources that can be used for SL transmission within a carrier. In other words, the resource(s) for SL transmission in the S-SSB period is in the resource pool. The SL transmission in the embodiments of the present disclosure may refer to at least one of PSCCH transmission or PSSCH transmission. In the time domain, the resource pool consists of a set of slots repeated over a resource pool period. Although the set of slots within the resource pool are logically organized in a consecutive way, actually the slots within the resource pool may be discretely distributed in the time domain.

As shown in FIG. 4, in the S-SSB window, M1 S-SSB occasions are included, which are S-SSB occasion N₀, S-SSB occasion N₁, . . . , S-SSB occasion N_{M1-1}, respectively.

A length of the S-SSB period is marked as “S-SSB Period” in FIG. 4. There is an offset between the starting of the S-SSB period and the first S-SSB occasion within the S-SSB period, which is marked as “T_{Offset}” in FIG. 4. There is an interval between two adjacent S-SSB occasions (e.g., between starting slots of the two adjacent S-SSB occasions), which is marked as “T_{Interval}” in FIG. 4. Accordingly, the configuration for one S-SSB period may include at least one of the parameter “S-SSB Period,” the parameter “T_{Offset},” the parameter “T_{Interval},” or a parameter “M1” indicating the number of S-SSB occasions within one S-SSB window (or one S-SSB period).

In 3GPP Release 16 (Rel-16) or Release 17 (Rel-17), the S-SSB period may include 160 ms, as specified in NR V2X. However, along with developments of network architectures and new service scenarios, the S-SSB period may have other values, which should not affect the principle of the disclosure.

The structure of S-SSB slot in FIG. 3 and distribution of occasions for S-SSB in FIG. 4 are only for illustrative purpose. It is contemplated that along with developments of network architectures and new service scenarios, the S-SSB may have other structures (for example, the S-SSB may include 4 OFDM symbols or 6 OFDM symbols in the time domain) and the distribution of occasions for S-SSB within one S-SSB period or within one window may change, which should not affect the principle of the present application.

The S-SSB occasions illustrated in FIG. 4, which are excluded from the resource pool in the time domain, may be referred to as first class S-SSB occasions, class-1 S-SSB occasions, C1 S-SSB occasions, or legacy S-SSB occasions. The distribution of class-1 S-SSB occasions may be denoted by at least one of the following parameters: S-SSB period, T_{Offset}, T_{Interval}, or M1 as stated above.

The S-SSB transmissions in unlicensed spectrum may be subject to a channel access procedure as stated above. That is, transmitting an S-SSB on a target S-SSB occasion requires a successful channel access procedure prior to the target S-SSB occasion. The channel access opportunities for transmitting S-SSB in unlicensed spectrum may be reduced due to resource collision or LBT failure. To compensate for the case that some S-SSB occasions are unavailable for transmitting S-SSB, it may be necessary to introduce additional S-SSB occasions for S-SSB transmitting in unlicensed spectrum to achieve the desired amount of channel access opportunities. For example, the additional S-SSB occasions may be included within the resource pool in the time domain. Such S-SSB occasions may be referred to as second class S-SSB occasions, class-2 S-SSB occasions, C2 S-SSB occasions or new S-SSB occasions.

FIG. 5 illustrates another exemplary distribution of S-SSB occasions in the time domain according to some embodiments of the present disclosure.

The S-SSB occasions illustrated in FIG. 5 may include class-1 S-SSB occasions and class-2 S-SSB occasions. The distribution of the class-1 S-SSB occasions within one S-SSB period may be determined based on at least one of the following parameters: S-SSB period, T_{Offset}, T_{Interval}, or M1 as stated above. The distribution of class-2 S-SSB occasions may also be configured or pre-configured to a UE in a similar manner or different manner.

In FIG. 5, each class-1 S-SSB occasion may be indicated by an index of N_{C1,i}, i∈[0, . . . , M1−1], wherein M1 indicates the total number of class-1 S-SSB occasions within the S-SSB period. Each class-2 S-SSB occasion may be indicated by an index of N_{C2,j}, j∈[0, . . . , M2−1], where M2 indicates the total number of class-2 S-SSB occasions within the S-SSB period.

In FIG. 5, all the class-2 S-SSB occasions may locate after all the class-1 S-SSB occasions within the S-SSB period.

FIG. 6 illustrates yet another exemplary distribution of S-SSB occasions in the time domain according to some embodiments of the present disclosure.

The difference between FIG. 6 and FIG. 5 lies in that: in FIG. 6, not all class-1 S-SSB occasions locate prior to class-2 S-SSB occasions. In some cases, one or more class-2 S-SSB occasions may locate between class-1 S-SSB occasions within the S-SSB period. Except for the above difference, the descriptions with respect to FIG. 5 may also apply to FIG. 6.

Referring to FIGS. 5 and 6, more S-SSB occasions typically result in more time-domain resources required for S-SSB. Therefore, for a certain resource pool, the resources for SL transmission (e.g., at least one of PSSCH transmission or PSCCH transmission) will be reduced due to introducing class-2 S-SSB occasions. To this end, how to efficiently utilize S-SSB resources (especially class-2 S-SSB occasions) is a key issue for sidelink design.

Given the above, embodiments of the present application provide improved solutions for resource allocation for SL transmission and S-SSB transmission in an unlicensed spectrum, which can efficiently utilize S-SSB resources (especially class-2 S-SSB occasions) in unlicensed spectra. More details will be described in the following text in combination with the appended drawings.

In the embodiments of the present application, a Tx UE may apply resource allocation mode 2 to determine resources in unlicensed spectra for an SL transmission. Considering new S-SSB occasions included in the resource pool (e.g., class-2 S-SSB occasions) are introduced to compensate for the unavailability of legacy S-SSB occasions (class-1 S-SSB occasions) due to resource collision or LBT failure, whether to use the new S-SSB occasions for other purposes, such as the SL transmission (e.g., at least one of PSSCH transmission or PSCCH transmission), may be based on the transmission on first several S-SSB occasion(s) within the same S-SSB period. For example, within one S-SSB period, if S-SSB transmission(s) is (are) detected on the first several S-SSB occasion(s), the remaining new S-SSB occasion(s) may be used for other purposes, so as to achieve high spectrum efficiency. More details will be described in the following text in combination with the appended drawings.

According to some embodiments of the present application, a UE, e.g., a Tx UE or an Rx UE, may obtain configuration information for S-SSB detection based on configuration or pre-configuration. In the embodiments of the present application, a Tx UE may be a UE initiating (or transmitting or performing) an SL transmission. An Rx UE may be a UE receiving an SL transmission.

Specifically, obtaining the configuration information for S-SSB detection based on configuration (i.e., the configuration information for S-SSB detection is configured to the UE) may refer to that: the configuration information for S-SSB detection is transmitted by a BS (e.g., BS 102 as shown in FIG. 1) to the UE via at least one of: a SIB message, a MIB message, an RRC signaling, a MAC CE, or DCI, such that the UE may receive the configuration information for S-SSB detection from the BS. In an embodiment of the present application, obtaining the configuration information for S-SSB detection based on configuration may apply to the scenario where the UE is in coverage of a network.

Specifically, obtaining the configuration information for S-SSB detection based on pre-configuration (i.e., the configuration information for S-SSB detection is pre-configured to the UE) may refer to that: the configuration information for S-SSB detection may be hard-wired into the UE or stored on a subscriber identity module (SIM) or universal subscriber identity module (USIM) card for the UE, such that the UE may obtain the configuration information for S-SSB detection within the UE. In an embodiment of the present application, obtaining the configuration information for S-SSB detection based on pre-configuration may apply to the scenario where the UE is out of coverage of the network.

The configuration information for S-SSB detection may include at least one of:
a first trigger condition of S-SSB detection for first UEs (e.g., Tx UEs) performing SL transmission;
a second trigger condition of S-SSB detection for second UEs (e.g., Rx UEs) receiving SL transmission;
a first minimum number of S-SSB occasion(s) for detection, wherein the S-SSB occasion(s) herein may include class-1 S-SSB occasion(s) and/or class-2 S-SSB occasion(s);
a second minimum number of S-SSB transmission(s) detected on S-SSB occasion(s), wherein the S-SSB occasion(s) herein may include class-1 S-SSB occasion(s) and/or class-2 S-SSB occasion(s); or
a third minimum number of S-SSB(s) transmitted on S-SSB occasion(s), wherein the S-SSB occasion(s) herein may include class-1 S-SSB occasion(s) and/or class-2 S-SSB occasion(s).

The first trigger condition may indicate that: the first UEs do not perform S-SSB detection, the first UEs perform S-SSB detection, or whether each first UE performs S-SSB detection is triggered by the first UE's implementation. For example, the first trigger condition may be denoted by a parameter “sl-TriggerConditionS-SSBDetection-Tx,” wherein a first value of the parameter may indicate that the first UEs do not perform S-SSB detection, a second value of the parameter may indicate that the first UEs perform S-SSB detection, and a third value of the parameter may indicate that whether each first UE performs S-SSB detection is triggered by the first UE's implementation.

The second trigger condition may indicate that: the second UEs do not perform S-SSB detection, the second UEs perform S-SSB detection, or whether each second UE performs S-SSB detection is triggered by the second UE's implementation. For example, the second trigger condition may be denoted by a parameter “sl-TriggerConditionS-SSBDetection-Rx,” wherein a first value of the parameter may indicate that the second UEs do not perform S-SSB detection, a second value of the parameter may indicate that the second UEs perform S-SSB detection, and a third value of the parameter may indicate that whether each second UE performs S-SSB detection is triggered by the second UE's implementation.

In some embodiments, a single trigger condition of S-SSB detection may apply to both the TX UEs and the Rx UEs. For example, the first trigger condition and the second trigger condition may be denoted by a single parameter “sl-TriggerConditionS-SSBDetection,” wherein a first value of the parameter may indicate that the UEs (including Tx UEs and Rx UEs) do not perform S-SSB detection, a second value of the parameter may indicate that the UEs perform S-SSB detection, and a third value of the parameter may indicate that whether each UE performs S-SSB detection is triggered by the UE's implementation.

The first minimum number (for example, denoted by a parameter “MinNumS-SSBOccasionForDetection”) may be used in determining whether a first condition is met, which will be described below. In an embodiment, the first minimum number may be a fixed value. In another embodiment, the first minimum number may be set based on an SCS of a carrier. For example, a higher SCS may correspond to a greater first minimum number.

The second minimum number (for example, denoted by a parameter MinNumS-SSBDetected) may be used in determining whether a second condition is met, which will be described below. In an embodiment, the second minimum number may be a fixed value. In another embodiment, the second minimum number may be set based on an SCS of a carrier. For example, a higher SCS may correspond to a greater second minimum number.

The third minimum number (for example, denoted by a parameter MinNumS-SSBTransmitted) may be used in determining whether a certain condition is met, which will be described below. In an embodiment, the third minimum number may be a fixed value. In another embodiment, the third minimum number may be set based on an SCS of a carrier. For example, a higher SCS may correspond to a greater third minimum number.

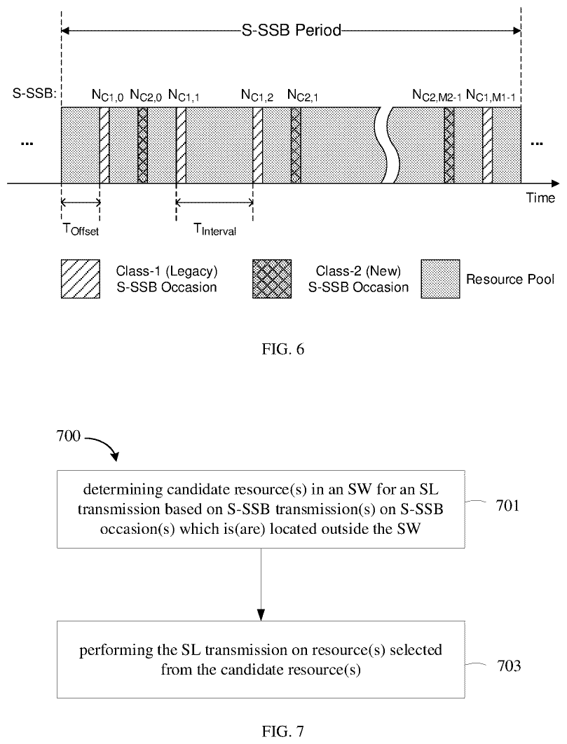

FIG. 7 illustrates a flowchart of an exemplary method 700 for resource allocation in an unlicensed spectrum according to some embodiments of the present application. The method 700 illustrated in FIG. 7 may be performed by a Tx UE (e.g., UE 101a or UE 101b in FIG. 1) or other apparatus with the like functions.

As shown in FIG. 7, in step 701, the UE may determine candidate resource(s) in an SW for an SL transmission based on S-SSB transmission(s) on S-SSB occasion(s) which is (are) located outside the SW. In step 703, the UE may perform the SL transmission on resource(s) selected from the candidate resource(s). In some embodiments, the candidate resource(s) may include candidate resource(s) determined based on the operations described with respect to FIG. 2.

In some embodiments of FIG. 7, to determine the candidate resource(s) in the SW for the SL transmission based on S-SSB transmission(s) on S-SSB occasion(s) which is (are) located outside the SW, the UE may first obtain the aforementioned configuration information for S-SSB detection based on configuration or pre-configuration as described above. The configuration information for S-SSB detection may be used in the subsequent operations performed by the UE.

In some embodiments of FIG. 7, the UE may transmit S-SSB or may not transmit S-SSB. Based on whether the UE transmits S-SSB or not, step 701 may further include Case 1 and Case 2.

### Case 1

In case 1, the UE does not transmit S-SSB. For example, not transmitting S-SSB by the UE may be configured by a BS or may be determined by the UE itself.

In case 1, the UE may determine whether to include (or exclude) class-2 S-SSB occasion(s) within the SW into (or from) candidate resource(s) for the SL transmission based on whether S-SSB transmission is detected on S-SSB occasion(s) prior to the SW. The specific operations in case 1 may be as follows.

Firstly, the UE, which does not transmit S-SSB, may trigger a resource selection for an SL transmission (e.g., at least one of a PSCCH transmission or PSSCH transmission) at a slot. The UE may define an SW in which the UE determines candidate resource(s) for the SL transmission. The SW may be within an S-SSB period, which may include class-1 S-SSB occasion(s) and/or class-2 S-SSB occasion(s).

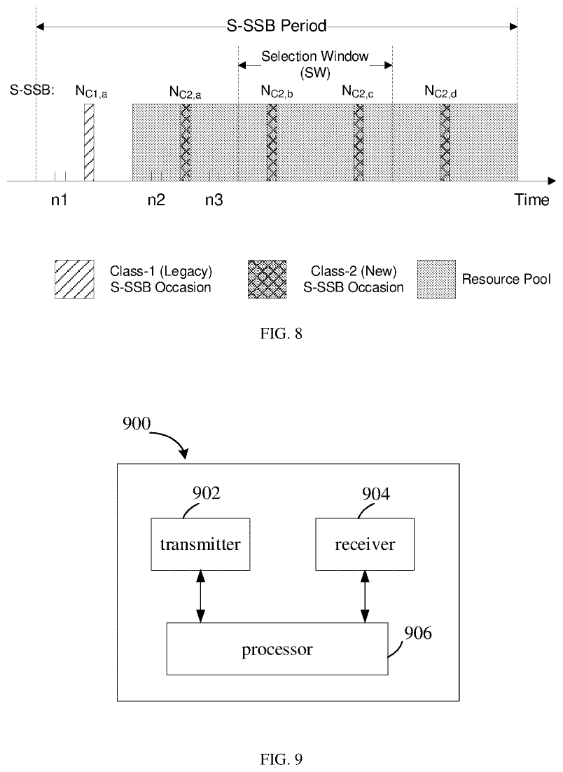

FIG. 8 illustrates an exemplary SW within an S-SSB period according to some embodiments of the present application.

Referring to FIG. 8, at slot #n1, slot #n2, or slot #n3, the UE may trigger a resource selection. The UE may define an SW in which the UE determines candidate resource(s) for an SL transmission (e.g., at least one of a PSCCH transmission or a PSSCH transmission). The SW is within an S-SSB period, wherein the S-SSB period includes one class-1 S-SSB occasion (e.g., denoted by N_{C1,a} in FIG. 8), and four class-2 S-SSB occasions (e.g., denoted by N_{C2,a}, N_{C2,b}, N_{C2,c}, and N_{C2,a} in FIG. 8) included in a resource pool.

In case 1, a first condition may be defined, which is that the number of S-SSB occasion(s) (which may include class-1 S-SSB occasion(s) and/or class-2 S-SSB occasion(s)) between a slot where the resource selection for the SL transmission is triggered and a starting point of the SW is greater than or equal to the first minimum number as defined above. Based on whether the first condition is met, case 1 may further include case 1-1 and case 1-2.

### Case 1-1

In case 1-1, the first condition is met. Taking FIG. 8 as an example, assuming that the first minimum number is 2, when the resource selection is triggered at slot #n1, the first condition is met. Based on whether the UE performs S-SSB detection, case 1-1 may further include case 1-1-1 and case 1-1-2.

### Case 1-1-1

In case 1-1-1, the UE does not perform S-SSB detection. For example, in the case that the first trigger condition of S-SSB detection as defined above indicates that the UE does not perform S-SSB detection, or in the case that the first trigger condition indicates that whether the UE performs S-SSB detection is triggered by the UE's implementation and the UE determines not to perform S-SSB detection, the UE does not perform S-SSB detection.

In the case that the UE does not perform S-SSB detection, the UE may exclude, at the slot where the resource selection is triggered (e.g., slot #n1), all class-2 S-SSB occasions within the SW from the candidate resource(s).

### Case 1-1-2

In case 1-1-2, the UE performs S-SSB detection. For example, in the case that the first trigger condition as defined above indicates that the UE performs S-SSB detection, or in the case that the first trigger condition indicates that whether the UE performs S-SSB detection is triggered by the UE's implementation and the UE determines to perform S-SSB detection, the UE will perform S-SSB detection.

In the case that the UE performs S-SSB detection, the UE may perform the following operations.
1) the UE may include, at the slot where the resource selection is triggered (e.g., slot #n1), all class-2 S-SSB occasions within the SW in the candidate resource(s);
2) the UE may perform S-SSB detection on S-SSB occasion(s) (which may include class-1 S-SSB occasion(s) and/or class-2 S-SSB occasion(s)) between the slot (e.g., slot #n1) and the starting point of the SW; and
3) in the case that a second condition is met, the UE may remain all the class-2 S-SSB occasions within the SW in the candidate resource(s); or in the case that the second condition is not met, the UE may exclude all the class-2 S-SSB occasions within the SW from the candidate resource(s), wherein the second condition may be that: the number of detected S-SSB transmission(s) within the S-SSB period where the SW is included is greater than or equal to the second minimum number as defined above.

Taking FIG. 8 as an example, assuming that the first minimum number is 2, the resource selection is triggered at slot #n1, and the second minimum number is 1, if the UE detects S-SSB transmission(s) on at least one of class-1 S-SSB occasion N_{C1,a} and class-2 S-SSB occasion N_{C2,a}, the second condition is met, and then the UE may remain class-2 S-SSB occasions N_{C2,b} and N_{C2,c} in the candidate resource(s). Otherwise, the second condition is not met, and then the UE may exclude class-2 S-SSB occasions N_{C2,b} and N_{C2,c} from the candidate resource(s).

### Case 1-2

In case 1-2, the first condition is not met. Taking FIG. 8 as an example, assuming that first minimum number is 2, when the resource selection is triggered at slot #n2 or slot #n3, the first condition is not met. Based on whether the UE performs S-SSB detection, case 1-2 may further include case 1-2-1 and case 1-2-2.

### Case 1-2-1

In case 1-2-1, the UE does not perform S-SSB detection on S-SSB occasion(s) (which may include class-1 S-SSB occasion(s) and/or class-2 S-SSB occasion(s)) prior to the slot where the resource selection is triggered (e.g., slot #n2 or slot #n3). For example, in the case that the first trigger condition as defined above indicates that the UE does not perform S-SSB detection, or in the case that the first trigger condition indicates that whether the UE performs S-SSB detection is triggered by the UE's implementation and the UE determines not to perform S-SSB detection, the UE does not perform S-SSB detection on S-SSB occasion(s) prior to slot.

In the case that the UE does not perform S-SSB detection on S-SSB occasion(s) prior to the slot, the UE may exclude all class-2 S-SSB occasions within the SW from the candidate resource(s).

### Case 1-2-2

In case 1-2-2, the UE performs S-SSB detection on S-SSB occasion(s) (which may include class-1 S-SSB occasion(s) and/or class-2 S-SSB occasion(s)) prior to the slot where the resource selection is triggered (e.g., slot #n2 or slot #n3). For example, in the case that the first trigger condition as defined above indicates that the UE performs S-SSB detection, or in the case that the first trigger condition indicates that whether the UE performs S-SSB detection is triggered by the first UE's implementation and the UE determines to perform S-SSB detection, the UE performs S-SSB detection on S-SSB occasion(s) prior to the slot.

In case 1-2-2, the UE's operations may also depend on whether the second condition as defined in case 1-1-2 is met or not.

In the case that the second condition is not met, the UE may exclude all class-2 S-SSB occasions within the SW from the candidate resource(s). Taking FIG. 8 as an example, assuming that the first minimum number is 2, the resource selection is triggered at slot #n2, and the second minimum number is 1, if the UE does not detect an S-SSB transmission on class-1 S-SSB occasion N_{C1,a}, the second condition is not met, and then the UE may exclude class-2 S-SSB occasions N_{C2,b} and N_{C2,c} from the candidate resource(s).

In the case that the second condition is met, the UE may include all the class-2 S-SSB occasions within the SW into the candidate resource(s). Taking FIG. 8 as an example, assuming that the first minimum number is 2, the resource selection is triggered at slot #n2, and the second minimum number is 1, if the UE detects an S-SSB transmission on class-1 S-SSB occasion N_{C1,a}, the second condition is met, and then the UE may include class-2 S-SSB occasions N_{C2,b} and N_{C2,c} into the candidate resource(s).

### Case 2

In case 2, the UE needs to transmit S-SSB. For example, transmitting S-SSB by the UE may be configured by a BS or may be determined by the UE itself.

In case 2, when the UE intends to transmit an S-SSB on a target S-SSB occasion, the UE may perform an LBT type 2 procedure prior to the target S-SSB occasion. In such case, if a CP extension (CPE) is used for the LBT type 2 procedure, then a length of the CPE is the same for all Tx UEs.

In case 2, the UE may determine whether to include (or exclude) class-2 S-SSB occasion(s) within the SW into (or from) candidate resource(s) for the SL transmission based on whether the UE transmits S-SSB(s) on S-SSB occasion(s) prior to the SW. The specific operations in case 2 may be as follows.

Firstly, the UE, which needs to transmit S-SSB, may trigger a resource selection for an SL transmission (e.g., at least one of a PSCCH transmission or PSSCH transmission) at a slot. The UE may define an SW in which the UE determines candidate resource(s) for the SL transmission. The SW may be within an S-SSB period, which may include class-1 S-SSB occasion(s) and/or class-2 S-SSB occasion(s). The specific examples may also be described with reference to FIG. 8.

In case 2, the UE's operations may also depend on whether the first condition as defined in case 1 is met or not. Based on whether the first condition is met, case 2 may further include case 2-1 and case 2-2.

### Case 2-1

In case 2-1, the first condition is met. Taking FIG. 8 as an example, assuming that the first minimum number is 2, when the resource selection is triggered at slot #n1, the first condition is met. In case 2-1, the UE may perform the following operations:
1) the UE may include, at the slot where the resource selection is triggered (e.g., slot #n1), all class-2 S-SSB occasions within the SW in the candidate resource(s);
2) the UE may attempt to transmit S-SSB(s) on S-SSB occasion(s) (which may include class-1 S-SSB occasion(s) and/or class-2 S-SSB occasion(s)) prior to the SW, wherein the S-SSB occasion(s) is (are) within the S-SSB period where the SW is included; and
3) in the case that a number of S-SSB(s) transmitted on the S-SSB occasion(s) prior to the SW in the S-SSB period is greater than or equal to the third minimum number as defined above, the UE may remain all the class-2 S-SSB occasions within the SW in the candidate resource(s); or in the case that the number of S-SSB(s) transmitted on the S-SSB occasion(s) prior to the SW in the S-SSB period is less than the third minimum number, the UE may exclude all the class-2 S-SSB occasions within the SW from the candidate resource(s).

Taking FIG. 8 as an example, assuming that the first minimum number is 2, the resource selection is triggered at slot #n1, and the third minimum number is 1, if the UE transmits S-SSB(s) on at least one of class-1 S-SSB occasion N_{C1,a} and class-2 S-SSB occasion N_{C2,a}, the UE may remain class-2 S-SSB occasions N_{C2,b} and N_{C2,c} in the candidate resource(s); otherwise, the UE may exclude class-2 S-SSB occasions N_{C2,b} and N_{C2,c} from the candidate resource(s).

### Case 2-2

In case 2-2, the first condition is not met. Taking FIG. 8 as an example, assuming that the first minimum number is 2, when the resource selection is triggered at slot #n2 or slot #n3, the first condition is not met.

In case 2-2, the UE's operations may further depend on whether the number of S-SSB(s) transmitted on S-SSB occasion(s) (which may include class-1 S-SSB occasion(s) and/or class-2 S-SSB occasion(s)) prior to the slot where the resource selection is triggered (e.g., slot #n2 or slot #n3) is greater than or equal to the third minimum number as defined above, wherein the S-SSB occasion(s) is (are) within the S-SSB period where the SW is included.

In the case that the number of S-SSB(s) transmitted on the S-SSB occasion(s) (which may include class-1 S-SSB occasion(s) and/or class-2 S-SSB occasion(s)) prior to the slot where the resource selection is triggered (e.g., slot #n2 or slot #n3) is greater than or equal to the third minimum number, the UE may include all class-2 S-SSB occasions within the SW in the candidate resource(s).

Taking FIG. 8 as an example, assuming that the first minimum number is 2, the resource selection is triggered at slot #n2, and the third minimum number is 1, if the UE transmits an S-SSB on class-1 S-SSB occasion N_{C1,a}, the UE may include class-2 S-SSB occasions N_{C2,b} and N_{C2,c} in the candidate resource(s).

In the case that the number of S-SSB(s) transmitted on the S-SSB occasion(s) prior to the slot where the resource selection is triggered is less than the third minimum number, the UE may exclude all the class-2 S-SSB occasions within the SW from the candidate resource(s).

Taking FIG. 8 as an example, assuming that the first minimum number is 2, the resource selection is triggered at slot #n2, and the third minimum number is 1, if the UE does not transmit an S-SSB on class-1 S-SSB occasion N_{C1,a}, the UE may exclude class-2 S-SSB occasions N_{C2,b} and N_{C2,c} from the candidate resource(s).

As described above, a Tx UE may include class-2 S-SSB occasion(s) in candidate resource(s) for an SL transmission in some cases. In other words, it is possible that the Tx UE may perform the SL transmission in a class-2 S-SSB occasion. Correspondingly, an Rx UE may need to perform a detection for an SL transmission on a class-2 S-SSB occasion in some cases. Some embodiments illustrating how a UE (e.g., an Rx UE) determines whether to perform a detection for an SL transmission on a class-2 S-SSB occasion will be described below.

In some embodiments, the UE may intend to synchronize via receiving S-SSB, so the UE may perform S-SSB detection on class-1 S-SSB occasion(s) and/or class-2 S-SSB occasion(s).

In some embodiments, the UE may intend to receive an SL transmission (e.g., at least one of a PSCCH transmission or a PSSCH transmission). In such embodiments, the UE may determine whether to perform a detection for an SL transmission on a particular class-2 S-SSB occasion based at least in part on whether the UE performs S-SSB detection.

In some embodiments, the UE may first obtain configuration information for S-SSB detection based on configuration or pre-configuration as described above. The configuration information for S-SSB detection may be used in the subsequent operations performed by the UE.

### Embodiment 1

In embodiment 1, the UE does not perform S-SSB detection on S-SSB occasion(s) (which may include class-1 S-SSB occasion(s) and/or class-2 S-SSB occasion(s)) prior to the particular class-2 S-SSB occasion based on configuration or pre-configuration, wherein the S-SSB occasion(s) may be within an S-SSB period including the particular class-2 S-SSB occasion.

In some examples, the UE not performing S-SSB detection may be pre-configured, predefined or fixed for the UE without requiring the second trigger condition of S-SSB detection as defined above.

In some other examples, in the case that the second trigger condition indicates that the UE does not perform S-SSB detection, or in the case that the second trigger condition indicates that whether the UE performs S-SSB detection is triggered by the UE's implementation and the UE determines not to perform S-SSB detection, the UE does not perform S-SSB detection on S-SSB occasion(s) prior to the particular class-2 S-SSB occasion within an S-SSB period including the particular class-2 S-SSB occasion.

In embodiment 1, the UE may perform a detection for the SL transmission on the particular class-2 S-SSB occasion.

### Embodiment 2

In embodiment 2, whether to perform S-SSB detection is based on the UE's implementation. For example, the second trigger condition of S-SSB detection as defined above may indicate that whether the UE performs S-SSB detection is triggered by the UE's implementation.

In some cases, if the UE determines not to perform S-SSB detection, then the UE does not perform S-SSB detection on S-SSB occasion(s) (which may include class-1 S-SSB occasion(s) and/or class-2 S-SSB occasion(s)) prior to the particular class-2 S-SSB occasion, wherein the S-SSB occasion(s) is within an S-SSB period including the particular class-2 S-SSB occasion. In such cases, the UE may perform a detection for the SL transmission on the particular class-2 S-SSB occasion.

In some cases, if the UE determines to perform S-SSB detection, then the UE performs S-SSB detection on S-SSB occasion(s) (which may include class-1 S-SSB occasion(s) and/or class-2 S-SSB occasion(s)) prior to the particular class-2 S-SSB occasion, wherein the S-SSB occasion(s) is within an S-SSB period including the particular class-2 S-SSB occasion.

In such cases, if the number of detected S-SSB transmission(s) within the S-SSB period is greater than or equal to the second minimum number as defined above, the UE may perform a detection for the SL transmission on the particular class-2 S-SSB occasion; otherwise, i.e., the number of detected S-SSB transmission(s) within the S-SSB period is less than the second minimum number, the UE may not perform a detection for the SL transmission on the particular class-2 S-SSB occasion.

### Embodiment 3

In embodiment 3, the UE performs S-SSB detection on S-SSB occasion(s) (which may include class-1 S-SSB occasion(s) and/or class-2 S-SSB occasion(s)) prior to the particular class-2 S-SSB occasion based on configuration or pre-configuration, wherein the S-SSB occasion(s) may be within an S-SSB period including the particular class-2 S-SSB occasion.

In some examples, the UE performing S-SSB detection may be pre-configured, predefined or fixed for the UE without requiring the second trigger condition of S-SSB detection as defined above.

In some other examples, in the case that the second trigger condition indicates that the UE performs S-SSB detection, or in the case that the second trigger condition indicates that whether the UE performs S-SSB detection is triggered by the UE's implementation and the UE determines to perform S-SSB detection, the UE performs S-SSB detection on S-SSB occasion(s) (which may include class-1 S-SSB occasion(s) and/or class-2 S-SSB occasion(s)) prior to the particular class-2 S-SSB occasion within an S-SSB period including the particular class-2 S-SSB occasion.

In embodiment 3, if the number of detected S-SSB transmission(s) within the S-SSB period is greater than or equal to the second minimum number as defined above, the UE may perform a detection for the SL transmission on the particular class-2 S-SSB occasion.

Otherwise, i.e., the number of detected S-SSB transmission(s) within the S-SSB period is less than the second minimum number, how to perform detection on the particular class-2 S-SSB occasion, e.g., to perform a detection for an SL transmission on the particular class-2 S-SSB occasion, to perform an S-SSB detection on the particular class-2 S-SSB occasion, or not to perform any detection on the particular class-2 S-SSB occasion, may be left for the UE's implementation.

FIG. 9 illustrates a simplified block diagram of an exemplary apparatus 900 for resource allocation in an unlicensed spectrum according to some embodiments of the present application. In some embodiments, the apparatus 900 may be or include at least part of a Tx UE (e.g., UE 101a or UE 101b in FIG. 1). In some embodiments, the apparatus 900 may be or include at least part of an Rx UE (e.g., UE 101a or UE 101b in FIG. 1). In some other embodiments, the apparatus 900 may be or include at least part of a BS (e.g., BS 102 in FIG. 1).

Referring to FIG. 9, the apparatus 900 may include at least one transmitter 902, at least one receiver 904, and at least one processor 906. The at least one transmitter 902 is coupled to the at least one processor 906, and the at least one receiver 904 is coupled to the at least one processor 906.

Although in this figure, elements such as the transmitter 902, the receiver 904, and the processor 906 are illustrated in the singular, the plural is contemplated unless a limitation to the singular is explicitly stated. In some embodiments of the present application, the transmitter 902 and the receiver 904 may be combined to one device, such as a transceiver. In some embodiments of the present application, the apparatus 900 may further include an input device, a memory, and/or other components. The transmitter 902, the receiver 904, and the processor 906 may be configured to perform any of the methods described herein (e.g., the method described with respect to any of FIGS. 2-8).

According to some embodiments of the present application, the apparatus 900 may be a Tx UE, and the transmitter 902, the receiver 904, and the processor 906 may be configured to perform operations of the method performed by a Tx UE as described with respect to any of FIGS. 7 and 8. For example, the processor 906 may be configured to: determine candidate resource(s) in an SW for an SL transmission based on S-SSB transmission(s) on S-SSB occasion(s) which is (are) located outside the SW; and perform the SL transmission on resource(s) selected from the candidate resource(s).

According to some embodiments of the present application, the apparatus 900 may be an Rx UE, and the transmitter 902, the receiver 904, and the processor 906 may be configured to perform operations of any method performed by an Rx UE as described in the present application. For example, the processor 906 may be configured to: determine whether to perform a detection for an SL transmission on a class-2 S-SSB occasion based at least in part on whether the UE performs S-SSB detection, wherein the class-2 S-SSB occasion is included within a resource pool in the time domain.

According to some embodiments of the present application, the apparatus 900 may be a BS, and the transmitter 902, the receiver 904, and the processor 906 may be configured to perform operations of any method performed by a BS as described in the present application. For example, the transmitter 902 may be configured to transmit configuration information for S-SSB detection, wherein the configuration information for S-SSB detection includes at least one of: a first trigger condition of S-SSB detection for first UEs performing SL transmission; a second trigger condition of S-SSB detection for second UEs receiving SL transmission; a first minimum number of S-SSB occasion(s) for detection; a second minimum number of S-SSB transmission(s) detected on S-SSB occasion(s); or a third minimum number of S-SSB(s) transmitted on S-SSB occasion(s).

In some embodiments of the present application, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transmitter 902 and/or the receiver 904, so as to perform operations of the method, e.g., as described with respect to any of FIGS. 2-8.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for resource allocation in unlicensed spectra including a processor and a memory. Computer programmable instructions for implementing a method for resource allocation in unlicensed spectra are stored in the memory, and the processor is configured to perform the computer programmable instructions to implement the method for resource allocation in unlicensed spectra. The method for resource allocation in unlicensed spectra may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for resource allocation in unlicensed spectra according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled with the at least one memory and configured to cause the UE to:
determine one or more candidate resources in a selection window (SW) for a sidelink (SL) transmission based on one or more sidelink synchronization signal block (S-SSB) transmissions on one or more S-SSB occasions which are located outside the SW; and
perform the SL transmission on one or more resources selected from the one or more candidate resources.

2. The UE of claim 1, wherein the at least one processor is further configured to cause the UE to obtain configuration information for S-SSB detection based on configuration or pre-configuration, wherein the configuration information for S-SSB detection indicates at least one of:
a first trigger condition of S-SSB detection for first UEs performing SL transmission;
a second trigger condition of S-SSB detection for second UEs receiving SL transmission;
a first minimum number of the one or more S-SSB occasions for detection;
a second minimum number of the one or more S-SSB transmissions detected on the one or more S-SSB occasions; or
a third minimum number of S-SSBs transmitted on the one or more S-SSB occasions.

3. The UE of claim 2, wherein one or more of:
the first trigger condition indicates at least one of the first UEs do not perform S-SSB detection, the first UEs perform the S-SSB detection, or whether each first UE performs the S-SSB detection is triggered by a first UE implementation; or
the second trigger condition indicates at least one of the second UEs do not perform the S-SSB detection, the second UEs perform the S-SSB detection, or whether each second UE performs the S-SSB detection is triggered by a second UE's UE implementation.

4. The UE of claim 2, wherein at least one of:
the first minimum number is a fixed value or based on a subcarrier spacing (SCS);
the second minimum number is a fixed value or based on the SCS; or
the third minimum number is a fixed value or based on the SCS.

5. The UE of claim 2, wherein the at least one processor is configured to cause the UE to receive the configuration information via at least one of: a master information block (MIB) message, a system information block (SIB) message, a radio resource control (RRC) signaling, a medium access control (MAC) control element (CE), or downlink control information (DCI).

6. The UE of claim 2, wherein if (1) the UE does not transmit S-SSB, (2) a number of S-SSB occasions between a slot where a resource selection for the SL transmission is triggered and a starting point of the SW is greater than or equal to the first minimum number, and (3) the UE does not perform S-SSB detection, then the at least one processor is further configured to cause the UE to exclude all class-2 S-SSB occasions within the SW from the one or more candidate resources at the slot, wherein the class-2 S-SSB occasions are included within a resource pool in a time domain.

7. The UE of claim 2, wherein if (1) the UE does not transmit S-SSB, (2) a number of S-SSB occasions between a slot where a resource selection for the SL transmission is triggered and a starting point of the SW is greater than or equal to the first minimum number, and (3) the UE performs S-SSB detection, then the at least one processor is further configured to cause the UE to:
include, at the slot, all class-2 S-SSB occasions within the SW in the one or more candidate resources, wherein the class-2 S-SSB occasions are included within a resource pool in a time domain;
perform S-SSB detection on the S-SSB occasions between the slot and the starting point of the SW; and
remain all the class-2 S-SSB occasions within the SW in the one or more candidate resources if a second condition is met, or exclude all the class-2 S-SSB occasions within the SW from the one or more candidate resources if the second condition is not met,
wherein the second condition is that a number of detected S-SSB transmissions within an S-SSB period where the SW is included is greater than or equal to the second minimum number.

8. The UE of claim 2, wherein if (1) the UE does not transmit S-SSB, and (2) a number of S-SSB occasions between a slot where a resource selection for the SL transmission is triggered and a starting point of the SW is less than the first minimum number, the at least one processor is further configured to cause the UE to:
if the UE does not perform S-SSB detection on the S-SSB occasions prior to the slot, exclude all class-2 S-SSB occasions within the SW from the one or more candidate resources, wherein the class-2 S-SSB occasions are included within a resource pool in a time domain;
if the UE performs S-SSB detection on the S-SSB occasions prior to the slot but a second condition is not met, exclude all the class-2 S-SSB occasions within the SW from the candidate resource(s); or
if the UE performs S-SSB detection on the one or more S-SSB occasions prior to the slot and the second condition is met, include all the class-2 S-SSB occasions within the SW into the one or more candidate resources,
wherein the second condition is that a number of detected S-SSB transmissions within an S-SSB period where the SW is included is greater than or equal to the second minimum number.

9. The UE of claim 2, wherein if (1) the UE needs to transmit S-SSB and (2) a number of S-SSB occasions between a slot where a resource selection for the SL transmission is triggered and a starting point of the SW is greater than or equal to the first minimum number, the at least one processor is further configured to cause the UE to:
include, at the slot, all class-2 S-SSB occasions within the SW in the one or more candidate resources, wherein the class-2 S-SSB occasions are included within a resource pool in a time domain;
attempt to transmit one or more S-SSBs on the S-SSB occasions prior to the SW within an S-SSB period where the SW is included; and
remain all the class-2 S-SSB occasions within the SW in the candidate resources if a number of one or more S-SSBs S SSB(s) transmitted on the one or more S-SSB occasions prior to the SW in the S-SSB period is greater than or equal to the third minimum number, or exclude all the class-2 S-SSB occasions within the SW from the candidate resources if the number of one or more S-SSBs transmitted on the S-SSB occasions prior to the SW in the S-SSB period is less than the third minimum number.

10. The UE of claim 2, wherein if (1) the UE needs to transmit S-SSB and (2) a number of S-SSB occasions between a slot where a resource selection for the SL transmission is triggered and a starting point of the SW is less than the first minimum number, the at least one processor is further configured to cause the UE to:
if a number of one or more S-SSBs transmitted on S-SSB occasions prior to the slot within an S-SSB period where the SW is included is greater than or equal to the third minimum number, include all class-2 S-SSB occasions within the SW in the candidate resources, wherein the class-2 S-SSB occasions are included within a resource pool in a time domain; or
if the number of one or more S-SSBs transmitted on the S-SSB occasions prior to the slot within the S-SSB period is less than the third minimum number, exclude all the class-2 S-SSB occasions within the SW from the candidate resources.

11. A user equipment (UE) for wireless communication, comprising:
at least one memory; and
at least one processor coupled with the at least one memory and configured to cause the UE to:
determine whether to perform a detection for a sidelink (SL) transmission on a class-2 sidelink synchronization signal block (S-SSB) occasion based at least in part on whether the UE performs S-SSB detection, wherein the class-2 S-SSB occasion is included within a resource pool in a time domain.

12. The UE of claim 11, wherein if the UE does not perform S-SSB detection on one or more S-SSB occasions prior to the class-2 S-SSB occasion within an S-SSB period including the class-2 S-SSB occasion based on configuration or pre-configuration, the at least one processor is further configured to cause the UE to perform a detection for the SL transmission on the class-2 S-SSB occasion.

13. The UE of claim 11, wherein:
whether to perform S-SSB detection is based on an implementation of the UE; and
if the UE does not perform S-SSB detection on one or more S-SSB occasions prior to the class-2 S-SSB occasion within an S-SSB period including the class-2 S-SSB occasion, the at least one processor is further configured to cause the UE to perform a detection for the SL transmission on the class-2 S-SSB occasion;
if the UE performs the S-SSB detection on the one or more S-SSB occasions prior to the class-2 S-SSB occasion within the S-SSB period and a number of detected S-SSB transmissions within the S-SSB period is greater than or equal to a second minimum number, the processor is further configured to perform a detection for the SL transmission on the class-2 S-SSB occasion; or
if the UE performs the S-SSB detection on the one or more S-SSB occasions prior to the class-2 S-SSB occasion within the S-SSB period and the number of detected S-SSB transmissions within the S-SSB period is less than the second minimum number, the processor is further configured not to perform a detection for the SL transmission on the class-2 S-SSB occasion.

14. The UE of claim 11, wherein if (1) the UE performs S-SSB detection on one or more S-SSB occasions prior to the class-2 S-SSB occasion within an S-SSB period including the class-2 S-SSB occasion based on configuration or pre-configuration, and (2) a number of detected S-SSB transmissions within the S-SSB period is greater than or equal to a second minimum number, the at least one processor is further configured to cause the UE to perform a detection for the SL transmission on the class-2 S-SSB occasion.

15. A base station (BS) for wireless communication, comprising:
at least one memory; and
at least one processor coupled with the at least one memory and configured to cause the BS to:
transmit configuration information for sidelink synchronization signal block (S-SSB) detection, wherein the configuration information for S-SSB detection includes at least one of:
a first trigger condition of S-SSB detection for first user equipment (UE) s performing SL transmission;
a second trigger condition of S-SSB detection for second UEs receiving SL transmission;
a first minimum number of one or more S-SSB occasions for detection;
a second minimum number of one or more S-SSB transmissions detected on the one or more S-SSB occasions; or
a third minimum number of one or more S-SSBs transmitted on the one or more S-SSB occasions.

16. A method performed by a user equipment (UE), the method comprising:
determining one or more candidate resources in a selection window (SW) for a sidelink (SL) transmission based on one or more sidelink synchronization signal block (S-SSB) transmissions on one or more S-SSB occasions which are located outside the SW; and
performing the SL transmission on one or more resources selected from the one or more candidate resources.

17. The method of claim 16, further comprising:
obtaining configuration information for S-SSB detection based on configuration or pre-configuration, wherein the configuration information for S-SSB detection indicates at least one of:
a first trigger condition of S-SSB detection for first UEs performing SL transmission;
a second trigger condition of S-SSB detection for second UEs receiving SL transmission;
a first minimum number of the one or more S-SSB occasions for detection;
a second minimum number of the one or more S-SSB transmissions detected on the one or more S-SSB occasions; or
a third minimum number of S-SSBs transmitted on the one or more S-SSB occasions.

18. The method of claim 17, wherein one or more of:
the first trigger condition indicates at least one of the first UEs do not perform S-SSB detection, the first UEs perform the S-SSB detection, or whether each first UE performs the S-SSB detection is triggered by a first UE implementation; or
the second trigger condition indicates at least one of the second UEs do not perform the S-SSB detection, the second UEs perform the S-SSB detection, or whether each second UE performs the S-SSB detection is triggered by a second UE implementation.

19. The method of claim 17, wherein at least one of:
the first minimum number is a fixed value or based on a subcarrier spacing (SCS);
the second minimum number is a fixed value or based on the SCS; or
the third minimum number is a fixed value or based on the SCS.

20. The method of claim 17, further comprising:
receiving the configuration information via at least one of: a master information block (MIB) message, a system information block (SIB) message, a radio resource control (RRC) signaling, a medium access control (MAC) control element (CE), or downlink control information (DCI)
